(19) United States
(12) Patent Application Publication
(10) Pub. No.: US 2012/0188297 A1
(43) Pub. Date: Jul. 26, 2012

(54) DISPLAY DEVICE

(75) Inventor: Takaji Numao, Osaka (JP)

(73) Assignee: SHARP KABUSHIKI KAISHA, Osaka-shi, Osaka (JP)

(21) Appl. No.: 13/501,156

(22) PCT Filed: May 24, 2010
(86) PCT No.: PCT/JP2010/058747

§ 371 Date: Apr. 10, 2012

(30) Foreign Application Priority Data
Oct. 23, 2009 (JP) 2009-244290

(51) Int. Cl. G09G 3/36; G09G 5/10

(52) U.S. Cl. 345/690; 345/89

(57) ABSTRACT

A pixel circuit includes a first sub-dot unit including a thin film transistor and a liquid crystal element, and a second sub-dot unit including thin film transistors and liquid crystal elements. During a selection period, some thin film transistors are turned to an ON state, and in a subsequent voltage adjustment period, another transistor is turned to the ON state. The second sub-dot unit is configured such that when shifting to the voltage adjustment period, a voltage applied to the liquid crystal element changes according to changes in states of the thin film transistors, excluding a case in which a maximum gradation voltage has been applied to the source line during the selection period. With this, for a display device pixels including a plurality of sub-dots, it is possible to set the transmittances of all of the plurality of sub-dots to a level corresponding to the maximum gradation voltage.

### TECHNICAL FIELD

The present invention relates to active matrix-type display devices, and in particular to a display device having pixels each constituted by a plurality of sub-dots.

### BACKGROUND ART

In recent years, screens of liquid crystal display devices have increasingly become large-sized, and 40-inch or larger screens are the mainstream especially for liquid crystal televisions. However, when a liquid crystal display screen is large, a difference between tones of color in a central part and those in a peripheral part is noticeable even when seen from the front. In particular, in a case in which a plurality of persons watch the liquid crystal television at the same time at home or such, a difference between viewing angles caused by a difference of angles for looking can often be problematic.

Therefore, in order to correct the viewing angles, there is known a liquid crystal display device having pixels each constituted by a plurality of sub-dots (Patent Document 1, for example). It should be noted that in a case of a color liquid crystal display device having color pixels each constituted by a plurality of sub-pixels (three sub-pixels of RGB, for example), each sub-pixel instead of each color pixel is referred to as a dot. However, in the following, descriptions will be given without making a strict distinction between a pixel and a dot.

FIG. 16 is a layout diagram of a pixel circuit described in Patent Document 1. FIG. 17 is an equivalent circuit diagram of the pixel circuit described in Patent Document 1. The pixel circuit shown in FIGS. 16 and 17 includes two sub-dot units Pa and Pb. The first sub-dot unit Pa includes a thin film transistor 91, a liquid crystal element 94, and a capacitive element 96, and the second sub-dot unit Pb includes thin film transistors 92 and 93, a liquid crystal element 95, and capacitive elements 97 and 98.

For the pixel circuit shown in FIG. 17, it is assumed that a voltage Vda is applied to a source line Sj during a voltage of a gate line Gi is at high level. At this time, the thin film transistors 91 and 92 are turned to an ON state, and electric charge in an amount corresponding to the voltage Vda applied from the source line Sj is stored in each of the liquid crystal elements 94 and 95 and the capacitive elements 96 and 97. The amount of the electric charge stored in the capacitive element 98 at this time point is represented by Qb. Thereafter, the voltage of the gate line Gi changes to low level, and a voltage of a gate line Gi+1 changes to high level. At this time, the thin film transistor 93 is turned to an ON state, and the electric charge stored in the capacitive element 98 and the electric charge stored in the liquid crystal element 95 and the capacitive element 97 are mixed. When a drain voltage of the thin film transistor 92 after the thin film transistor 93 has been turned to the ON state, a capacitance value of the liquid crystal element 95, a capacitance value of the capacitive element 97, and a capacitance value of the capacitive element 98 are respectively taken as Vdb, Clc, Cs, and Cb, an expression (1) shown below is established.

(Clc+Cs)Vda+Qb=(Clc+Cs+Cb)Vdb (1)

In a steady state in which luminance of the display screen does not change, gradation voltages having the same absolute value but different polarities are applied to the liquid crystal element 95 for each frame. At this time, an expression (2) shown below is established.

Qb=Cb×(−Vdb) (2)

From the expression (1) and the expression (2), an expression (3) shown below is established.

Vdb=(Clc+Cs)Vda/(Clc+Cs+2Cb) (3)

Here, assuming that Clc+Cs=8Cb, an expression (4) shown below is established.

Vdb=(4/5)×Vda (4)

FIG. 18 is a chart showing a relation between a source line voltage and a voltage applied to liquid crystals (a drain voltage of the thin film transistors 91 and 92). As shown in FIG. 18, the voltage applied to liquid crystals for the first sub-dot unit Pa (indicated by a dashed line) is equal to the source line voltage Vda. By contrast, the voltage applied to liquid crystals for the second sub-dot unit Pb (indicated by a solid line) is 800 of the source line voltage Vda, that is, 80% of the voltage applied to liquid crystals for the first sub-dot unit Pa. It is possible to improve viewing angle characteristics by writing different voltages to the two sub-dot units Pa and Pb in this manner when writing the gradation voltage to the pixel circuit.

### PRIOR ART DOCUMENT

### Patent Document

[Patent Document 1] Japanese Laid-Open Patent Publication No. 2006-330634

### SUMMARY OF THE INVENTION

### Problems to be Solved by the Invention

However, some liquid crystal elements have a characteristic that its transmittance is minimized (or maximized) when a certain voltage is applied, and the transmittance increases (or decreases) if a voltage that exceeds this certain voltage is applied. FIG. 19 is a chart showing a relation between an applied voltage and transmittance when TN (Twisted Nematic) liquid crystals are used in a normally white mode. In an example shown in FIG. 19, the transmittance of a liquid crystal element is minimized when the applied voltage is V0, and becomes greater than a minimum value when the applied voltage exceeds V0.

A case in which a liquid crystal element having the characteristic shown in FIG. 19 is used taking V0 as 5 V is considered. In this case, it is assumed that a 5 V voltage is applied to a source line to write the voltage V0 to the first sub-dot unit Pa in order to minimize transmittance of the first sub-dot unit Pa. At this time, as a 4 V voltage is written to the second sub-dot unit Pb, transmittance of the second sub-dot unit Pb is not minimized. Further, it is assumed that a 6.25 V (=5×5/4) voltage is applied to the source line to write the voltage V0 to the second sub-dot unit Pb in order to minimize the transmittance of second sub-dot unit Pb. At this time, as the 6.25 V voltage is written to the first sub-dot unit Pa, the transmittance of the first sub-dot unit Pa is not minimized.

As described above, in the pixel circuit shown in FIG. 17, it is not possible to determine the voltage of the source line such that the transmittances of both of the two sub-dot units Pa and Pb are minimized, and the pixel circuit is always in a state in which at least one of the transmittances of the sub-dot units is not minimized (a state in which the transmittance deviates from the minimum). Consequently, contrast decreases in the pixel circuit shown in FIG. 17. Further, in a VATN (Vertical Alignment Twisted Nematic) mode which is one type of a VA (Vertical Alignment) mode, the viewing angle characteristics deteriorate because the deviation in the transmittance is noticeable when viewed from an oblique direction.

Thus, an object of the present invention is to provide a display device having pixels each constituted by a plurality of sub-dots, for which transmittances can be set to a level corresponding to a maximum gradation voltage for all of the plurality of sub-dots.

### Means for Solving the Problems

According to a first aspect of the present invention, there is provided an active matrix-type display device, including: a plurality of scanning signal lines; a plurality of video signal lines; a plurality of control lines to which a maximum gradation voltage is applied, the maximum gradation voltage being a voltage whose absolute value is maximum among gradation voltages applied to the video signal lines; and a plurality of pixel circuits respectively provided corresponding to intersections between the scanning signal lines and the video signal lines, each pixel circuit including a first sub-dot unit and a second sub-dot unit, wherein the first sub-dot unit includes: a first display element having a capacitance; and a first active element provided between a corresponding one of the video signal lines and one terminal of the first display element, and configured to be turned to an ON state during a selection period of a corresponding one of the scanning signal lines, the second sub-dot unit includes: a second display element having a capacitance; a second active element provided between the corresponding one of the video signal lines and one terminal of the second display element, and configured to be turned to the ON state during the selection period; a capacitive element having a first terminal and a second terminal; a third active element configured to be turned to the ON state during the selection period; and a fourth active element configured to be turned to the ON state during a voltage adjustment period following the selection period, and the second sub-dot unit is configured such that when shifting to the voltage adjustment period, a voltage applied to the second display element changes according to changes in states of the second to fourth active elements, excluding a case in which the maximum gradation voltage has been applied to the corresponding one of the video signal lines during the selection period.

According to a second aspect of the present invention, in the first aspect of the present invention, the third active element is provided between the first terminal and a corresponding one of the control lines, and the fourth active element is provided between the first terminal and the one terminal of the second display element.

According to a third aspect of the present invention, in the first aspect of the present invention, the third active element is provided between the first terminal and a corresponding one of the control lines, the fourth active element is provided between the first terminal and the second terminal, and the second terminal is connected to the one terminal of the second display element.

According to a fourth aspect of the present invention, in the first aspect of the present invention, the third active element is provided between the first terminal and the corresponding one of the video signal lines, the fourth active element is provided between the first terminal and a corresponding one of the control lines, and the second terminal is connected to the one terminal of the second display element.

According to a fifth aspect of the present invention, in the first aspect of the present invention, the voltage adjustment period coincides with a selection period of a subsequent one of the scanning signal lines.

According to a sixth aspect of the present invention, in the first aspect of the present invention, the pixel circuit is provided on a liquid crystal panel having a first substrate, a second substrate, a liquid crystal layer disposed between the first and second substrates, a first alignment film disposed on a surface of the first substrate facing toward the liquid crystal layer, and a second alignment film disposed on a surface of the second substrate facing toward the liquid crystal layer, the liquid crystal layer includes liquid crystal molecules having a negative dielectric anisotropy, and the first and second alignment films cause the liquid crystal molecules to be aligned substantially vertically to surfaces of the films and in orientations perpendicular to each other.

According to a seventh aspect of the present invention, in the sixth aspect of the present invention, a pretilt angle of the liquid crystal molecule in the neighborhood of the first and second alignment films is not greater than 89 degrees.

According to an eighth aspect of the present invention, in the sixth aspect of the present invention, each of the first and second alignment films within each pixel circuit includes two or more areas having different alignment orientations.

### Effects of the Invention

According to the first aspect of the present invention, during the selection period, the first and second active elements are turned to the ON state, and the gradation voltage is applied to the first and second display elements from the video signal line. When shifting to the voltage adjustment period after applying a voltage other than the maximum gradation voltage to the video signal line during the selection period, the voltage applied to the second display element changes. Accordingly, after the voltage adjustment period, the voltages applied to the first display element and to the second display element are different. When writing the voltage other than the maximum gradation voltage to the pixel circuit, it is possible to improve viewing angle characteristics by writing different voltages to the two sub-dot units in this manner. Further, when shifting to the voltage adjustment period after applying the maximum gradation voltage to the video signal line during the selection period, the voltage applied to the second display element does not change. Accordingly, even after the voltage adjustment period, the voltages applied to the first display element and to the second display element are the same. When writing the maximum gradation voltage to the pixel circuit, it is possible to set the transmittances of both of the two sub-dot units to a level corresponding to the maximum gradation voltage by writing the same voltage to the two sub-dot units in this manner, thereby increasing contrast.

According to the second aspect of the present invention, during the selection period, the first to third active elements are turned to the ON state, and the gradation voltage is applied to the first and second display elements from the video signal line, and the maximum gradation voltage is applied to the first terminal of the capacitive element from the control line. At this time, electric charge in an amount corresponding to the gradation voltage is stored in the second display element, and electric charge in an amount corresponding to the maximum gradation voltage is stored in the capacitive element. During the voltage adjustment period, the fourth active element is turned to the ON state, and the one terminal of the second display element (the terminal on the side of the second active element) and the first terminal of the capacitive element are short-circuited. In a case in which a voltage other than the maximum gradation voltage has been applied to the video signal line during the selection period, the voltage applied to the second display element changes when the second display element and the capacitive element are short-circuited. By contrast, in a case in which the maximum gradation voltage has been applied to the video signal line during the selection period, the voltage applied to the second display element does not change even when the second display element and the capacitive element are short-circuited. In this manner, it is possible to configure the second sub-dot unit with which when shifting to the voltage adjustment period, the voltage applied to the second display element changes according to the changes in states of the second to fourth active elements, excluding the case in which the maximum gradation voltage has been applied to the video signal line during the selection period. According to the display device having the pixel circuit including the second sub-dot unit thus configured, it is possible to improve the viewing angle characteristics, and to set the transmittances of both of the two sub-dot units to the level corresponding to the maximum gradation voltage, thereby increasing contrast.

According to the third aspect of the present invention, during the selection period, the first to third active elements are turned to the ON state, and the gradation voltage is applied to the first and second display elements and to the second terminal of the capacitive element from the video signal line, and the maximum gradation voltage is applied to the first terminal of the capacitive element from the control line. At this time, electric charge in an amount corresponding to the gradation voltage is stored in the second display element, and electric charge in an amount corresponding to the difference between the maximum gradation voltage and the gradation voltage is stored in the capacitive element. During the voltage adjustment period, the fourth active element is turned to the ON state, the first terminal and the second terminal of the capacitive element are short-circuited, and the electric charge stored in the capacitive element is discharged. In a case in which a voltage other than the maximum gradation voltage has been applied to the video signal line during the selection period, the voltage applied to the second display element changes when the two terminals of the capacitive element are short-circuited. By contrast, in a case in which the maximum gradation voltage has been applied to the video signal line during the selection period, the voltage applied to the second display element does not change even when the two terminals of the capacitive element are short-circuited. In this manner, it is possible to configure the second sub-dot unit with which when shifting to the voltage adjustment period, the voltage applied to the second display element changes according to the changes in states of the second to fourth active elements, excluding the case in which the maximum gradation voltage has been applied to the video signal line during the selection period. According to the display device having the pixel circuit including the second sub-dot unit thus configured, it is possible to improve the viewing angle characteristics, and to set the transmittances of both of the two sub-dot units to the level corresponding to the maximum gradation voltage, thereby increasing contrast.

According to the fourth aspect of the present invention, during the selection period, the first to third active elements are turned to the ON state, and the gradation voltage is applied to the first and second display elements and the first and second terminals of the capacitive element from the video signal line.

At this time, electric charge in an amount corresponding to the gradation voltage is stored in the second display element, and electric charge stored in the capacitive element becomes zero. During the voltage adjustment period, the fourth active element is turned to the ON state, and the maximum gradation voltage is applied to the first terminal of the capacitive element from the control line. In a case in which a voltage other than the maximum gradation voltage has been applied to the video signal line during the selection period, the voltage applied to the second display element changes when the voltage is applied to the first terminal of the capacitive element from the control line. By contrast, in a case in which the maximum gradation voltage has been applied to the video signal line during the selection period, the voltage applied to the second display element does not change even when the voltage is applied to the first terminal of the capacitive element from the control line. In this manner, it is possible to configure the second sub-dot unit with which when shifting to the voltage adjustment period, the voltage applied to the second display element changes according to the changes instates of the second to fourth active elements, excluding the case in which the maximum gradation voltage has been applied to the video signal line during the selection period. According to the display device having the pixel circuit including the second sub-dot unit thus configured, it is possible to improve the viewing angle characteristics, and to set the transmittances of both of the two sub-dot units to the level corresponding to the maximum gradation voltage, thereby increasing contrast.

According to the fifth aspect of the present invention, by making the voltage adjustment period coincide with the selection period of the subsequent scanning signal line, it is possible to control the fourth active element by using the scanning signal line for controlling the first to third active elements, thereby reducing the number of the signal lines provided for the display device.

According to the sixth to eighth aspects of the present invention, for a liquid crystal display device in a normally black mode which is referred to as a VATN mode, it is possible to improve the viewing angle characteristics, and to set the transmittances of the two sub-dot units to the level corresponding to the maximum gradation voltage, thereby increasing contrast.

### BRIEF DESCRIPTION OF THE DRAWINGS

FIG. 1 is a block diagram illustrating a configuration of a liquid crystal display device according to a first embodiment of the present invention.

FIG. 2 is an equivalent circuit diagram of a pixel circuit included in the liquid crystal display device shown in FIG. 1.

FIG. 3 is a signal waveform chart of the liquid crystal display device shown in FIG. 1.

FIG. 4 is a chart showing a relation between a source line voltage and a voltage applied to liquid crystals for the liquid crystal display device shown in FIG. 1.

FIG. 5 is a block diagram illustrating a configuration of a liquid crystal display device according to a second embodiment of the present invention.

FIG. 6 is an equivalent circuit diagram of a pixel circuit included in the liquid crystal display device shown in FIG. 5.

FIG. 7 is a signal waveform chart of the liquid crystal display device shown in FIG. 5.

FIG. 8 is a chart showing a relation between a source line voltage and a voltage applied to liquid crystals for the liquid crystal display device shown in FIG. 5.

FIG. 9 is an equivalent circuit diagram of a pixel circuit included in a liquid crystal display device according to a third embodiment of the present invention.

FIG. 10 is a signal waveform chart of the liquid crystal display device according to the third embodiment of the present invention.

FIG. 11 is a view illustrating a working principle of the liquid crystal display device in a VATN mode.

FIG. 12 is a view illustrating positional relations between alignment orientations of alignment films and absorption axes of polarizing plates in a single domain area included in each of pixels of the liquid crystal display device in the VATN mode.

FIG. 13 is a view illustrating a pretilt angle of a liquid crystal molecule.

FIG. 14 is a view illustrating four domain areas included in each pixel of the liquid crystal display device in the VATN mode.

FIG. 15 is a chart showing alignments of the liquid crystal molecules of the liquid crystal display device in the VATN mode.

FIG. 16 is a layout diagram of a pixel circuit of a conventional liquid crystal display device.

FIG. 17 is an equivalent circuit diagram of the pixel circuit shown in FIG. 16.

FIG. 18 is a chart showing a relation between a source line voltage and a voltage applied to liquid crystals for the conventional liquid crystal display device.

FIG. 19 is a chart showing a relation between an applied voltage and transmittance for liquid crystals in a normally white mode.

### MODE FOR CARRYING OUT THE INVENTION

### First Embodiment

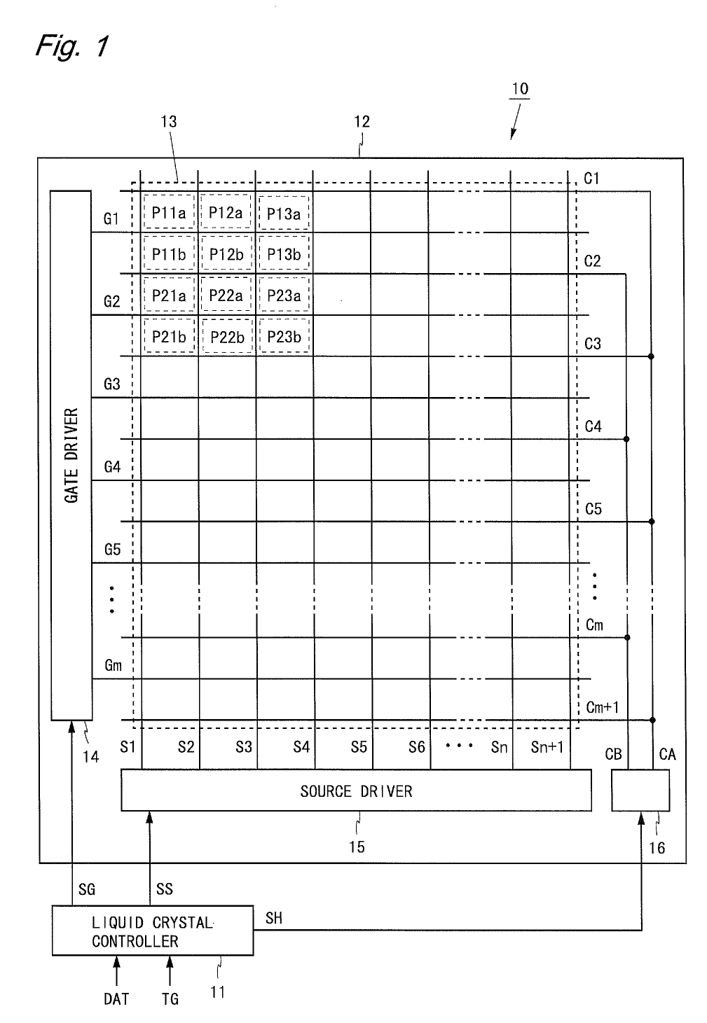

FIG. 1 is a block diagram illustrating a configuration of a liquid crystal display device according to a first embodiment of the present invention. A liquid crystal display device 10 shown in FIG. 1 is an active matrix-type display device, and provided with a liquid crystal controller 11 and a liquid crystal panel 12. The liquid crystal panel 12 includes a display unit 13, a gate driver 14, a source driver 15, and an auxiliary capacitor line driver 16. The liquid crystal panel 12 is provided with polarizing plates and a backlight that are not depicted in the figure on a front or a back surface of the panel. In the following description, the liquid crystal display device 10 is assumed to perform gradation display in 256 levels using TN liquid crystals in a normally white mode. Further, m and n are integers not smaller than 1, i is an integer not smaller than 1 and not greater than m, and j is an integer not smaller than 1 and not greater than n.

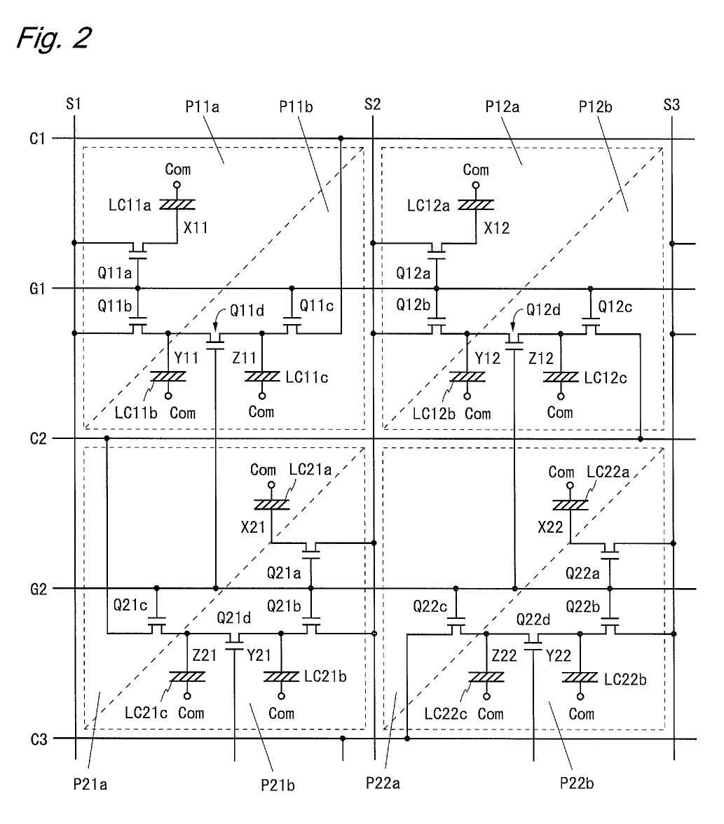

The display unit 13 is provided with m gate lines G1 to Gm, (n+1) source lines S1 to Sn+1, and (m×n) pixel circuits. The gate lines G1 to Gm are disposed in parallel to each other, and the source lines S1 to Sn+1 are disposed in parallel to each other so as to intersect perpendicularly with the gate lines G1 to Gm. The (m×n) pixel circuits are provided respectively corresponding to intersections between the gate lines and the source lines (see FIG. 2 that will be referred later). The display unit 13 is further provided with (m+1) auxiliary capacitor lines C1 to Cm+1 disposed in parallel to the gate lines G1 to Gm. The auxiliary capacitor lines Ci and Ci+1 are provided so as to sandwich the gate line Gi. The gate lines G1 to Gm serve as scanning signal lines, the source lines S1 to Sn+1 serve as video signal lines, and the auxiliary capacitor lines C1 to Cm+1 serve as control lines.

To the liquid crystal controller 11, a data signal DAT and a group of timing control signals TG are supplied from an outside of the liquid crystal display device 10. Based on these signals, the liquid crystal controller 11 outputs a group of gate control signals SG for controlling the gate driver 14, a group of source control signals SS for controlling the source driver 15, and a group of auxiliary capacitor line control signals SH for controlling the auxiliary capacitor line driver 16.

The gate driver 14 applies a selection voltage at high level sequentially to the gate lines G1 to Gm based on the group of gate control signals SG. The source driver 15 applies gradation voltages in 256 levels to the source lines S1 to Sn+1 based on the group of source control signals SS. At this time, the source driver 15 switches the polarity of the gradation voltages applied to the source lines, according to a predetermined rule. Based on the group of auxiliary capacitor line control signals SH, the auxiliary capacitor line driver applies an auxiliary capacitor line signal CA to the odd-numbered auxiliary capacitor lines C1, C3, and so on, and an auxiliary capacitor line signal CB to the even-numbered auxiliary capacitor lines C2, C4, and so on. A voltage whose absolute value is maximum among the 256-level gradation voltages applied to the source lines S1 to Sn+1 (hereinafter referred to as a maximum gradation voltage) is applied to the auxiliary capacitor lines C1 to Cm+1. By the actions of the gate driver 14, the source driver 15, and the auxiliary capacitor line driver 16, the selection voltage is applied sequentially to the gate lines G1 to Gm, the gradation voltages are applied to the source lines S1 to Sn+1, and the maximum gradation voltage is applied to the auxiliary capacitor lines C1 to Cm+1. This allows a desired image to be displayed in the display unit 13.

In the liquid crystal display device 10, in order to increase a viewing angle, a single pixel is constituted by a plurality of sub-dots. Specifically, each pixel circuit includes two sub-dot units. Hereinafter, the pixel circuit arranged in i-th row and j-th column is represented by Pij, and the two sub-dot units included in the pixel circuit Pij are respectively referred to as a first sub-dot unit Pija and a second sub-dot unit Pijb.

FIG. 2 is an equivalent circuit diagram of the pixel circuit included in the liquid crystal display device 10. FIG. 2 illustrates four pixel circuits (eight sub-dot units) provided corresponding to the intersections between the gate lines G1 and G2 and the source lines S1 to S3 as an example. In the liquid crystal display device 10, the two sub-dot units Pij a and Pijb are provided corresponding to the intersection between the gate line Gi and the source line Sj. The first sub-dot unit Pij a includes a thin film transistor Qija and a liquid crystal element LCija. The second sub-dot unit Pijb includes thin film transistors Qijb, Qijc, and Qijd and liquid crystal elements LCijb and LCijc. The thin film transistors Qija, Qijb, Qijc, and Qijd respectively serve as first to fourth active elements. The liquid crystal elements LCija, LCijb, and LCijc all have a predetermined capacitance, and respectively serve as a first display element, a second display element, and a capacitive element.

A gate terminal of the thin film transistor Qija is connected to the gate line Gi, and a drain terminal of the thin film transistor Qija is connected to one electrode of the liquid crystal element LCija (hereinafter referred to as a dot electrode Xij). A source terminal of the thin film transistor Qij a is connected to the source line Sj when i is an odd number, and to the source line Sj+1 when i is an even number. A gate terminal of the thin film transistor Qijb is connected to the gate line Gi, and a drain terminal of the thin film transistor Qijb is connected to one electrode of the liquid crystal element LCijb (hereinafter referred to as a dot electrode Yij). A source terminal of the thin film transistor Qijb is connected to the source line Sj when i is an odd number, and to the source line Sj+1 when i is an even number.

A gate terminal of the thin film transistor Qijc is connected to the gate line Gi, and a drain terminal of the thin film transistor Qijc is connected to one electrode of the liquid crystal element LCijc (hereinafter referred to as a dot electrode Zij). A source terminal of the thin film transistor Qijc is connected to the auxiliary capacitor line Ci when j is an odd number, and to the auxiliary capacitor line Ci+1 when j is an even number. A gate terminal of the thin film transistor Qijd is connected to the gate line Gi+1, a source terminal of the thin film transistor Qijd is connected to the dot electrode Yij, and a drain terminal of the thin film transistor Qijd is connected to the dot electrode Zij. The other electrodes of the liquid crystal elements LCija, LCijb, and LCijc are configured as a counter electrode Com that is common to all of the pixel circuits. To the counter electrode Com, a predetermined counter voltage (hereinafter, fixed to 0 V) is applied.

Between the dot electrodes Xij, Yij, and Zij and the counter electrode Com, liquid crystals are present respectively.

In order to represent this in FIG. 2, the liquid crystal elements LCija, LCijb, and LCijc are illustrated respectively between the dot electrodes Xij, Yij, and Zij and the counter electrode Com. According to the magnitude of the voltage applied to liquid crystals, light which enters into the liquid crystals through the polarizing plate from the backlight are polarized. With this, it is possible to control a display condition of the sub-dot units.

In FIG. 2, a pixel circuit P12 (including sub-dot units P12a and P12b) and a pixel circuit P21 (including sub-dot units P21a and P21b) are provided corresponding to the source line S2. Out of these two pixel circuits, the pixel circuit P12 corresponding to the gate line G1 is disposed on a right side of the source line S2, and the pixel circuit P21 corresponding to the gate line G2 is disposed on a left side of the source line S2. In this manner, two adjacent pixel circuits that are provided corresponding to a single source line are disposed on the opposite sides from each other with respect to the source line Sj (specifically, in zigzag arrangement). Accordingly, by fixing the polarity of the voltage applied to the source line Sj to positive in a first frame period and to negative in a subsequent second frame period, and by fixing the polarity of the voltage applied to the source line Sj+1 to negative in the first frame period and to positive in the second frame period, it is possible to perform dot inversion drive without inverting the polarity of the voltages applied to the source lines every single horizontal period.

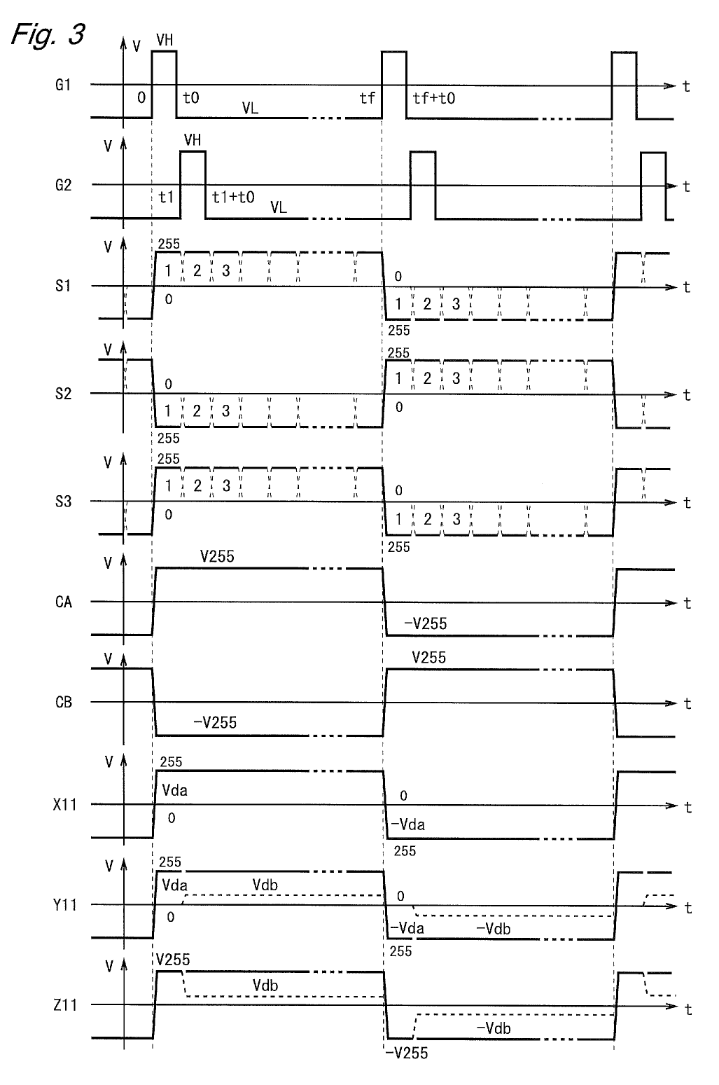

FIG. 3 is a signal waveform chart of the liquid crystal display device 10. FIG. 3 illustrates changes of the voltages applied to the gate lines G1 and G2, the voltages applied to the source lines S1 to S3, the voltage of the auxiliary capacitor line signal CA (the voltage applied to the odd-numbered auxiliary capacitor lines C1, C3, and so on), the voltage of the auxiliary capacitor line signal CB (the voltage applied to the even-numbered auxiliary capacitor lines C2, C4, and so on), and the voltages of the dot electrodes X11, Y11, and Z11 when the above voltages are applied.

A driving method of the liquid crystal display device 10 will be now described with reference to FIG. 3. In FIG. 3, a time period from a time 0 to a time t0 corresponds to a selection period of the gate line G1 (a selection period of the pixel circuits P1j in a first row). Further, a time period from a time t1 to a time (t1+t0) corresponds to a selection period of the gate line G2 (a selection period of the pixel circuits P2j in a second row) and a voltage adjustment period of the pixel circuits P1j in the first row. Hereinafter, a positive maximum gradation voltage is represented by V255, and a negative maximum gradation voltage is represented by (−V255).

In the frame period starting at the time 0, the auxiliary capacitor line driver 16 sets the voltage of the auxiliary capacitor line signal CA to the positive maximum gradation voltage V255, and the voltage of the auxiliary capacitor line signal CB to the negative maximum gradation voltage (−V255). In a frame period starting at a time tf, the auxiliary capacitor line driver 16 sets the voltage of the auxiliary capacitor line signal CA to the negative maximum gradation voltage (−V255), and the voltage of the auxiliary capacitor line signal CB to the positive maximum gradation voltage V255.

At the time 0, the gate driver 14 applies a selection voltage VH at high level to the gate line G1. With this, the thin film transistors Q1ja, Q1jb, and Q1jc are turned to an ON state in the pixel circuits P1j in the first row. During the time period from the time 0 to the time t0, in order to write voltages to the pixel circuits P1j in the first row, the source driver 15 applies positive gradation voltages to the odd-numbered source lines S1, S3, and so on, and negative gradation voltages to the even-numbered source lines S2, S4, and so on.

During the time period from the time 0 to the time t0, in the pixel circuit P11, the positive gradation voltage is applied to the dot electrodes X11 and Y11 from the source driver through the source line S1, and the positive maximum gradation voltage V255 is applied to the dot electrode Z11 from the auxiliary capacitor line driver 16 through the auxiliary capacitor line C1. This also applies to other pixel circuits P13, P15, and so on in the first row and the odd-numbered columns. In the pixel circuit P12, the negative gradation voltage is applied to the dot electrodes X12 and Y12 from the source driver through the source line S2, and the negative maximum gradation voltage (−V255) is applied to the dot electrode Z12 from the auxiliary capacitor line driver 16 through the auxiliary capacitor line C2. This also applies to other pixel circuits P14, P16, and so on in the first row and the even-numbered columns.

Next, at the time t0, the gate driver 14 applies a non-selection voltage VL at low level to the gate line G1. With this, the thin film transistors Q1ja, Q1jb, and Q1jc are turned to an OFF state in the pixel circuits P1j in the first row.

Then, at the time t1, the gate driver 14 applies the selection voltage VH to the gate line G2. With this, the thin film transistor Q1jd is turned to the ON state in the pixel circuits P1j in the first row, and the thin film transistors Q2ja, Q2jb, and Q2jc are turned to the ON state in the pixel circuits P2j in the second row. During the time period from the time t1 to the time (t1+t0), in order to write voltages to the pixel circuits P2j in the second row, the source driver 15 applies positive gradation voltages to the odd-numbered source lines S1, S3, and so on, and negative gradation voltages to the even-numbered source lines S2, S4, and so on.

During the time period from the time t1 to the time (t1+t0), in the pixel circuit P21, the negative gradation voltage is applied to the dot electrodes X21 and Y21 from the source driver through the source line S2, and the negative maximum gradation voltage (−V255) is applied to the dot electrode Z21 from the auxiliary capacitor line driver 16 through the auxiliary capacitor line C2. This also applies to other pixel circuits P23, P25, and so on in the second row and the odd-numbered columns. In the pixel circuit P22, the positive gradation voltage is applied to the dot electrodes X22 and Y22 from the source driver 15 through the source line S3, and the positive maximum gradation voltage V255 is applied to the dot electrode Z22 from the auxiliary capacitor line driver 16 through the auxiliary capacitor line C3. This also applies to other pixel circuits P24, P26, and so on in the second row and the even-numbered columns. Further, in the pixel circuits P1j in the first row, the dot electrode Y1j and the dot electrode Z1j are short-circuited, and the voltages of the dot electrodes Y1j and Z1j become the same (details will be described later).

Next, at the time (t1+t0), the gate driver 14 applies the non-selection voltage VL to the gate line G2. With this, the thin film transistor Q1jd is turned to the OFF state in the pixel circuits P1j in the first row, and the thin film transistors Q2ja, Q2jb, and Q2jc are turned to the OFF state in the pixel circuits P2j in the second row.

At the time t0, electric charge in an amount corresponding to the gradation voltage applied from the source line S1 (hereinafter referred to as a source line voltage Vda) is stored in each of the liquid crystal elements LC11a and LC11b. Further, electric charge in an amount corresponding to the positive maximum gradation voltage V255 applied from the auxiliary capacitor line C1 is stored in the liquid crystal element LC11c. When the thin film transistor Q1jd is turned to the ON state at the time t1, the dot electrode Y11 and the dot electrode Z11 are short-circuited, and the voltages of the dot electrodes Y11 and Z11 become the same. For a voltage Vdb of the dot electrodes Y11 and Z11 after the time t1, an expression (5) shown below is established. Therefore, the voltage Vdb is obtained by an expression (6) shown below.

Cb·Vda+Cc·V255=(Cb+Cc)Vdb (5)

Vdb=(Cb·Vda+Cc·V255)/(Cb+Cc) (6)

Here, Cb and Cc respectively represent capacitance values of the liquid crystal elements LCijb and LCijc.

Next, effects of the liquid crystal display device 10 according to this embodiment will be described. Here, when it is assumed that Cb=4Cc, an expression (7) shown below is derived.

Vdb=(4·Vda+V255)/5 (7)

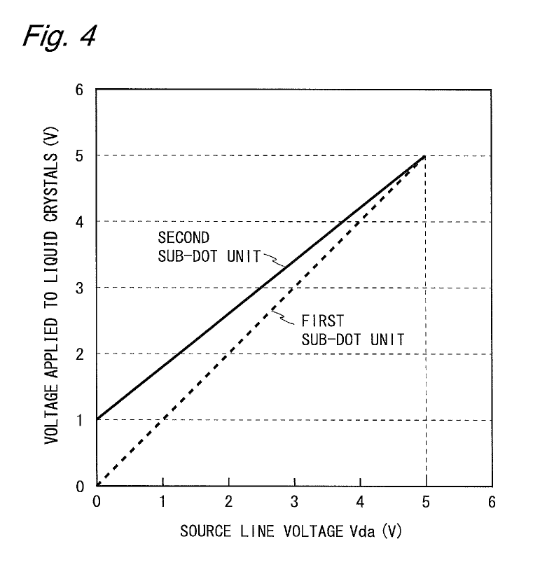

FIG. 4 is a chart showing a relation between the source line voltage Vda and a voltage applied to liquid crystals. FIG. 4 illustrates the voltage applied to liquid crystals in the first sub-dot unit Pija (the voltage of the dot electrode X11, indicated by a dashed line) and the voltage applied to liquid crystals in the second sub-dot unit Pijb (the voltages of the dot electrodes Y11 and Z11, indicated by a solid line) in a case in which the source line voltage Vda changes from 0 V to the maximum gradation voltage V255 (5 V, here).

As shown in FIG. 4, when the source line voltage Vda is lower than V255, the voltage applied to liquid crystals in the second sub-dot unit Pijb is different from the voltage applied to liquid crystals in the first sub-dot unit Pija. When writing a voltage other than the maximum gradation voltage V255 to the pixel circuit Pij, it is possible to improve viewing angle characteristics by writing different voltages to the two sub-dot units Pija and Pijb in this manner. Further, when the source line voltage Vda is equal to V255, the voltage applied to liquid crystals in the second sub-dot unit Pijb is the same as the voltage applied to liquid crystals in the first sub-dot unit Pija (both at 5 V). When writing the maximum gradation voltage V255 to the pixel circuit Pij, it is possible to set the transmittances of both of the two sub-dot units to a level corresponding to the maximum gradation voltage by writing the same voltage to the two sub-dot units Pija and Pijb in this manner, thereby increasing contrast.

As described above, according to the liquid crystal display device 10 of this embodiment, the second sub-dot unit Pijb includes the liquid crystal element LCijb (second display element) having a capacitance, the thin film transistor Qijb (second active element) provided between the source line Sj (or the source line Sj+1) and one terminal of the liquid crystal element LCijb and turned to be the ON state during the selection period of the gate line Gi, the liquid crystal element LCijc (capacitive element) having a first terminal and a second terminal, the thin film transistor Qijc (third active element) turned to the ON state during the selection period, and the thin film transistor Qijd (fourth active element) turned to the ON state during the voltage adjustment period (the selection period of the gate line Gi+1) after the selection period. The thin film transistor Qij c is provided between the first terminal of the liquid crystal element LCijc and the auxiliary capacitor line Ci (or the auxiliary capacitor line Ci+1), and the thin film transistor Qijd is provided between the first terminal of the liquid crystal element LCijc and the one terminal of the liquid crystal element LCijb (the terminal on a side of the thin film transistor Qijb).

During the selection period, the thin film transistors Qija, Qijb, and Qijc are turned to the ON state, the gradation voltage is applied to the liquid crystal elements LCija and LCijb from the source line Sj (or the source line Sj+1), and the maximum gradation voltage is applied to the first terminal of the liquid crystal element LCijc from the auxiliary capacitor line Ci (or the auxiliary capacitor line Ci+1). At this time, electric charge in an amount corresponding to the gradation voltage is stored in the liquid crystal element LCijb, and electric charge in an amount corresponding to the maximum gradation voltage is stored in the liquid crystal element LCijc. During the voltage adjustment period, the thin film transistor Qijd is turned to the ON state, and the one terminal of the liquid crystal element LCijb (the terminal on the side of the thin film transistor Qijb) and the first terminal of the liquid crystal element LCij c are short-circuited. In a case in which a voltage other than the maximum gradation voltage has been applied to the source line during the selection period, the voltage applied to the liquid crystal element LCijb changes when the liquid crystal element LCijb and the liquid crystal element LCijc are short-circuited. By contrast, in a case in which the maximum gradation voltage has been applied to the source line during the selection period, the voltage applied to the liquid crystal element LCijb does not change even if the liquid crystal element LCijb and the liquid crystal element LCij c are short-circuited. Accordingly, in the second sub-dot unit Pijb, when shifting to the voltage adjustment period, the voltage applied to the liquid crystal element LCijb changes according to changes in states of the thin film transistors Qijb, Qijc, and Qijd, excluding the case in which the maximum gradation voltage has been applied to the source line during the selection period. Therefore, according to the display device having the pixel circuit Pij including the second sub-dot unit Pijb thus configured, it is possible to improve the viewing angle characteristics, and to set the transmittances of both of the two sub-dot units to the level corresponding to the maximum gradation voltage, thereby increasing contrast.

Further, according to the liquid crystal display device 10 of this embodiment, the voltage adjustment period coincides with the selection period of a subsequent source line. With this, it is possible to control the thin film transistor Qijd by using the gate line for controlling the thin film transistors Qija, Qijb, and Qijc, thereby reducing the number of the signal lines provided for the display device.

It should be noted that, as shown in FIG. 19, the transmittance does not change (constant at 100%) even when a voltage from 0 V to V_{100%} (a voltage within a range X) is applied to the liquid crystals. Accordingly, by sufficiently decreasing an absolute value of the source line voltage Vda, it is possible to set the transmittances of both of the two sub-dot units to be 100%. Therefore, according to the liquid crystal display device 10 of this embodiment, being unable to set the transmittance to be 100% cannot be the reason for decreasing contrast.

### Second Embodiment

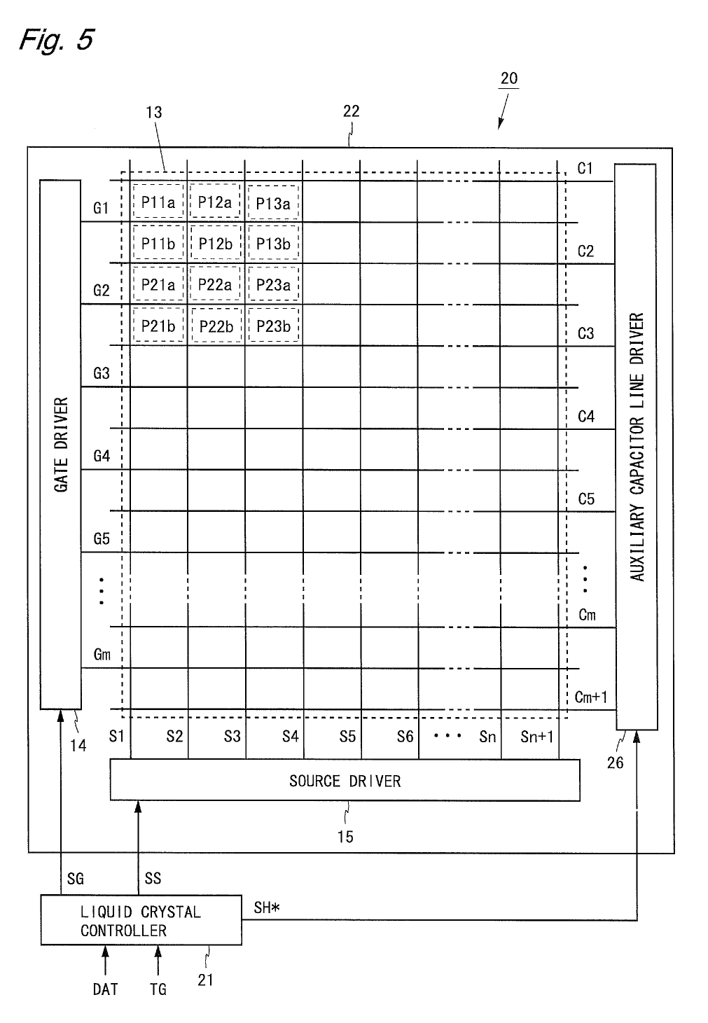

FIG. 5 is a block diagram illustrating a configuration of a liquid crystal display device according to a second embodiment of the present invention. A liquid crystal display device 20 shown in FIG. 5 is an active matrix-type display device, and provided with a liquid crystal controller 21 and a liquid crystal panel 22. The liquid crystal panel 22 includes the display unit 13, the gate driver 14, the source driver 15, and an auxiliary capacitor line driver 26. The same components of this embodiment as those of the first embodiment are denoted by the same reference symbols, and explanations for these components are omitted. In the following, different points from the first embodiment are described.

Based on the data signal DAT and the group of the timing control signals TG, the liquid crystal controller 21 outputs the group of gate control signals SG, the group of source control signals SS, and a group of auxiliary capacitor line control signals SH*. However, the group of auxiliary capacitor line control signals SH* outputted from the liquid crystal controller 21 is different from the group of auxiliary capacitor line control signals SH outputted from the liquid crystal controller 11 according to the first embodiment. Based on the group of auxiliary capacitor line control signals SH*, the auxiliary capacitor line driver 26 controls the voltages of the auxiliary capacitor lines C1 to Cm+1 (details will be described later).

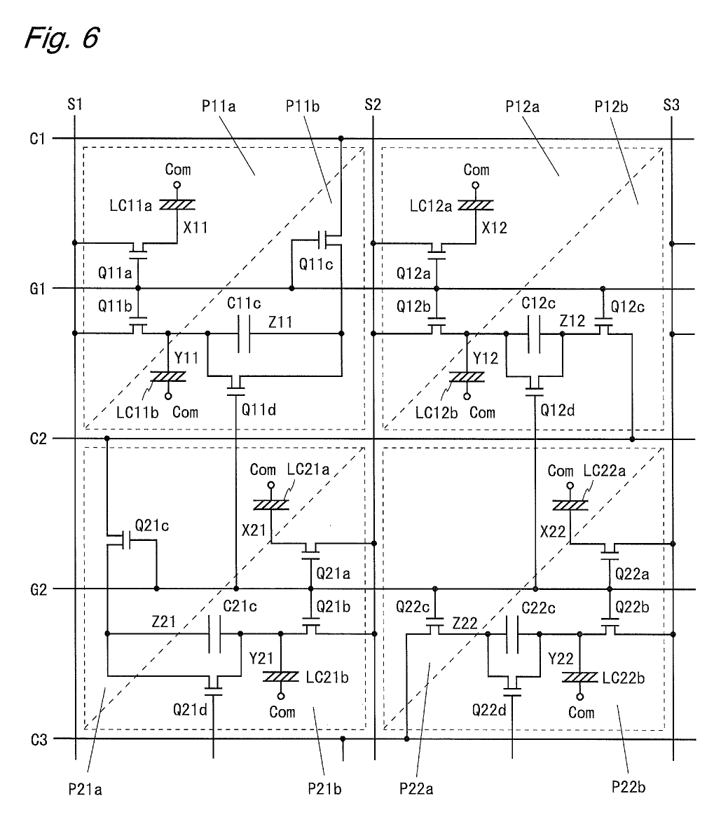

FIG. 6 is an equivalent circuit diagram of the pixel circuit included in the liquid crystal display device 20. Similarly to the first embodiment, the first sub-dot unit Pija includes the thin film transistor Qija and the liquid crystal element LCija. Unlike the first embodiment, the second sub-dot unit Pijb includes the thin film transistors Qijb, Qijc, and Qijd, the liquid crystal element LCijb, and a capacitor Cijc that serves as a capacitive element.

The connection form of the thin film transistors Qija and Qijb is the same as the first embodiment. One electrodes of the liquid crystal elements LCija and LCijb (electrodes that are not the common electrode Com) are respectively referred to as the dot electrodes Xij and Yij. The gate terminal of the thin film transistor Qijc is connected to the gate line Gi, and the drain terminal of the thin film transistor Qijc is connected to one electrode of the capacitor Cijc (hereinafter referred to as the dot electrode Zij). The source terminal of the thin film transistor Qijc is connected to the auxiliary capacitor line Ci when j is an odd number, and to the auxiliary capacitor line Ci+1 when j is an even number. The gate terminal of the thin film transistor Qijd is connected to the gate line Gi+1, the source terminal of the thin film transistor Qijd is connected to the dot electrode Yij, and the drain terminal of the thin film transistor Qijd is connected to the dot electrode Zij. The other electrodes of the liquid crystal elements LCija and LCijb are configured as the counter electrode Com that is common to all of the pixel circuits. The other electrode of the capacitor Cijc is connected to the dot electrode Yij.

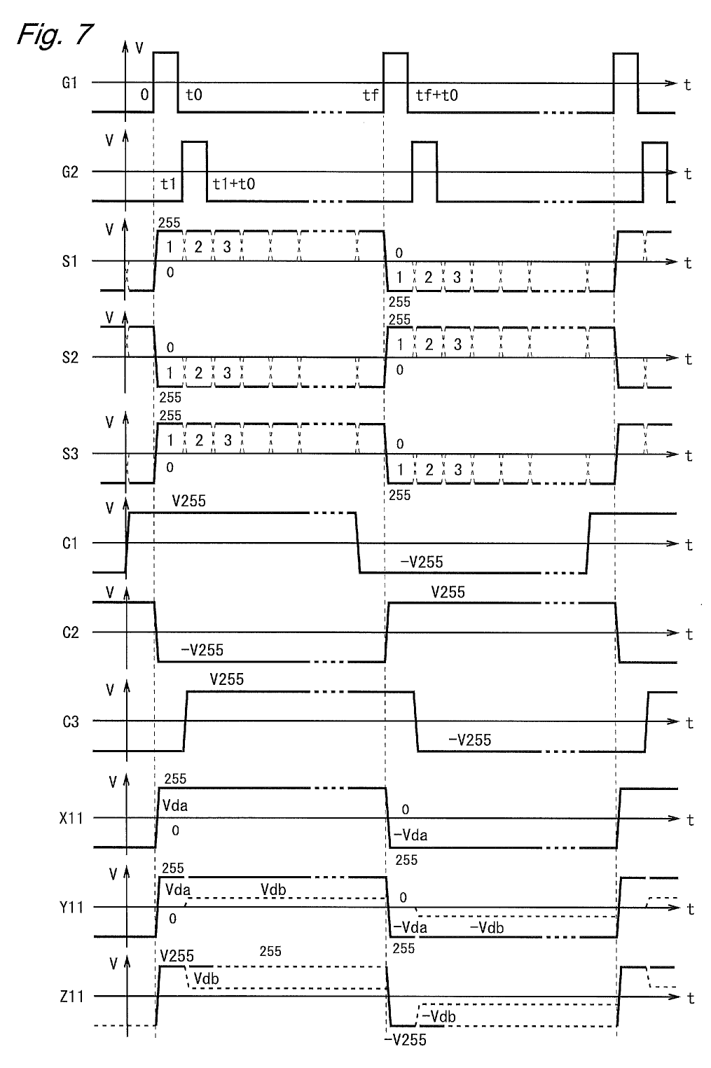

FIG. 7 is a signal waveform chart of the liquid crystal display device 20. FIG. 7 illustrates changes of the voltages applied to the gate lines G1 and G2, the voltages applied to the source lines S1 to S3, the voltages applied to the auxiliary capacitor lines C1 to C3, and the voltages of the dot electrodes X11, Y11, and Z11 when the above voltages are applied.

A driving method of the liquid crystal display device 20 will be now described with reference to FIG. 7. At the time 0, the gate driver 14 applies the selection voltage VH to the gate line G1. With this, the thin film transistors Q1ja, Q1jb, and Q1jc are turned to the ON state in the pixel circuits P1j in the first row. During the time period from the time 0 to the time t0, in order to write voltages to the pixel circuits P1j in the first row, the source driver 15 applies the positive gradation voltages to the odd-numbered source lines S1, S3, and so on, and the negative gradation voltages to the even-numbered source lines S2, S4, and so on. During this period, the auxiliary capacitor line driver 26 applies the positive maximum gradation voltage V255 to the auxiliary capacitor line C1, and the negative maximum gradation voltage (−V255) to the auxiliary capacitor line C2.

During the time period from the time 0 to the time t0, in the pixel circuit P11, the positive gradation voltage is applied to the dot electrodes X11 and Y11 from the source driver through the source line S1, and the positive maximum gradation voltage V255 is applied to the dot electrode Z11 from the auxiliary capacitor line driver 26 through the auxiliary capacitor line C1. This also applies to other pixel circuits P13, P15, and so on in the first row and the odd-numbered columns. In the pixel circuit P12, the negative gradation voltage is applied to the dot electrodes X12 and Y12 from the source driver through the source line S2, and the negative maximum gradation voltage (−V255) is applied to the dot electrode Z12 from the auxiliary capacitor line driver 26 through the auxiliary capacitor line C2. This also applies to other pixel circuits P14, P16, and so on in the first row and the even-numbered columns.

Next, at the time t0, the gate driver 14 applies the non-selection voltage VL to the gate line G1. With this, the thin film transistors Q1ja, Q1jb, and Q1jc are turned to the OFF state in the pixel circuits P1j in the first row.

Then, at the time t1, the gate driver 14 applies the selection voltage VH to the gate line G2. With this, the thin film transistor Q1jd is turned to the ON state in the pixel circuits P1j in the first row, and the thin film transistors Q2ja, Q2jb, and Q2jc are turned to the ON state in the pixel circuits P2j in the second row. During the time period from the time t1 to the time (t1+t0), in order to write voltages to the pixel circuits P2j in the second row, the source driver 15 applies the positive gradation voltages to the odd-numbered source lines S1, S3, and so on, and the negative gradation voltages to the even-numbered source lines S2, S4, and so on. During this period, the auxiliary capacitor line driver 26 applies the negative maximum gradation voltage (−V255) to the auxiliary capacitor line C2, and the positive maximum gradation voltage V255 to the auxiliary capacitor line C3.

During the time period from the time t1 to the time (t1+t0), in the pixel circuit P21, the negative gradation voltage is applied to the dot electrodes X21 and Y21 from the source driver through the source line S2, and the negative maximum gradation voltage (−V255) is applied to the dot electrode Z21 from the auxiliary capacitor line driver 26 through the auxiliary capacitor line C2. This also applies to other pixel circuits P23, P25, and so on in the second row and the odd-numbered columns. In the pixel circuit P22, the positive gradation voltage is applied to the dot electrodes X22 and Y22 from the source driver 15 through the source line S3, and the positive maximum gradation voltage V255 is applied to the dot electrode Z22 from the auxiliary capacitor line driver 26 through the auxiliary capacitor line C3. This also applies to other pixel circuits P24, P26, and so on in the second row and the even-numbered columns. Further, in the pixel circuits P1j in the first row, the two electrodes of the capacitor C1jc are short-circuited, and the voltages of the dot electrodes Y1j and Z1j become the same (details will be described later).

Next, at the time (t1+t0), the gate driver 14 applies the non-selection voltage VL to the gate line G2. With this, the thin film transistor Q1jd is turned to the OFF state in the pixel circuits P1j in the first row, and the thin film transistors Q2ja, Q2jb, and Q2jc are turned to the OFF state in the pixel circuits P2j in the second row.

At the time t0, electric charge in an amount corresponding to the gradation voltage applied from the source line S1 (source line voltage Vda) is stored in each of the liquid crystal elements LC11a and LC11b. Further, electric charge in an amount corresponding to a difference between the positive maximum gradation voltage V255 applied from the auxiliary capacitor line C1 and the source line voltage Vda is stored in the capacitor C1ic. When the thin film transistor Q1jd is turned to the ON state at the time t1, the dot electrode Y11 and the dot electrode Z11 are short-circuited, and the voltages of the dot electrodes Y11 and Z11 become the same. For the voltage Vdb of the dot electrodes Y11 and Z11 after the time t1, an expression (8) shown below is established. Therefore, the voltage Vdb is obtained by an expression (9) shown below.

Cb·Vda+Cc·(Vda−V255)=Cb·Vdb (8)

Vdb={(Cb+Cc)·Vda−Cc·V255}/Cb (9)

Here, Cb represents a capacitance value of the liquid crystal element LCijb, and Cc represents a capacitance value of the capacitor Cijc.

Next, effects of the liquid crystal display device 20 according to this embodiment will be described. Here, when it is assumed that Cb=4Cc, an expression (10) shown below is derived.

Vdb=(5·Vda−V255)/4 (10)

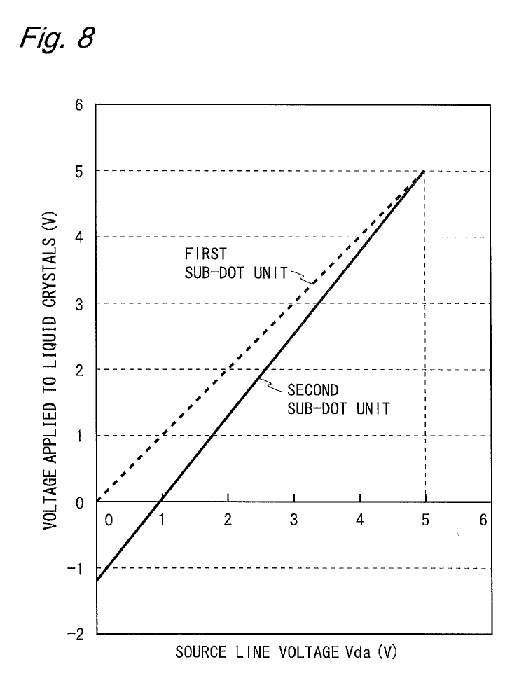

FIG. 8 is a chart showing a relation between the source line voltage Vda and a voltage applied to liquid crystals. Similarly to FIG. 4, FIG. 8 illustrates the voltage applied to liquid crystals in the first sub-dot unit Pija (the voltage of the dot electrode X11, indicated by a dashed line) and the voltage applied to liquid crystals in the second sub-dot unit Pijb (the voltages of the dot electrodes Y11 and Z11, indicated by a solid line).

As shown in FIG. 8, when the source line voltage Vda is lower than V255, the voltage applied to liquid crystals in the second sub-dot unit Pijb is different from the voltage applied to liquid crystals in the first sub-dot unit Pija. Further, when the source line voltage Vda is equal to V255, the voltage applied to liquid crystals in the second sub-dot unit Pijb is the same as the voltage applied to liquid crystals in the first sub-dot unit Pija. Accordingly, similarly to the first embodiment, when writing a voltage other than the maximum gradation voltage V255 to the pixel circuit Pij, it is possible to improve viewing angle characteristics by writing different voltages to the two sub-dot units Pija and Pijb. In addition, similarly to the first embodiment, when writing the maximum gradation voltage V255 to the pixel circuit Pij, it is possible to set the transmittances of both of the two sub-dot units to a level corresponding to the maximum gradation voltage by writing the same voltage to the two sub-dot units Pija and Pijb, thereby increasing contrast.

As described above, according to the liquid crystal display device 20 of this embodiment, the second sub-dot unit Pijb includes, as a capacitive element, the capacitor Cijc having a first terminal and a second terminal. The thin film transistor Qijc (third active element) is provided between the first terminal of the capacitor Cijc and the auxiliary capacitor line Ci (or the auxiliary capacitor line Ci+1), the thin film transistor Qijd (fourth active element) is provided between the first terminal and the second terminal of the capacitor Cijc, and the second terminal of the capacitor Cijc is connected to the one terminal of the liquid crystal element LCijb (the terminal on the side of the thin film transistor Qijb as the second active element).

During the selection period, the thin film transistors Qija, Qijb, and Qijc are turned to the ON state, the gradation voltage is applied to the liquid crystal elements LCija and LCijb, and the second terminal of the capacitor Cijc from the source line Sj (or the source line Sj+1), and the maximum gradation voltage is applied to the first terminal of the capacitor Cijc from the auxiliary capacitor line Ci (or the auxiliary capacitor line Ci+1). At this time, electric charge in an amount corresponding to the gradation voltage is stored in the liquid crystal element LCijb, and electric charge in an amount corresponding to a difference between the maximum gradation voltage and the gradation voltage is stored in the capacitor Cijc. During the voltage adjustment period, the thin film transistor Qijd is turned to the ON state, the two terminals of the capacitor Cijc are short-circuited, and the electric charge stored in the capacitor Cijc is discharged. In a case in which a voltage other than the maximum gradation voltage has been applied to the source line during the selection period, the voltage applied to the liquid crystal element LCijb changes when the two terminals of the capacitor Cijc are short-circuited. By contrast, in a case in which the maximum gradation voltage has been applied to the source line during the selection period, the voltage applied to the liquid crystal element LCijb does not change even if the two terminals of the capacitor Cijc are short-circuited. Accordingly, in the second sub-dot unit Pijb, when shifting to the voltage adjustment period, the voltage applied to the liquid crystal element LCijb changes according to changes in states of the thin film transistors Qijb, Qijc, and Qijd, excluding the case in which the maximum gradation voltage has been applied to the source line during the selection period. Therefore, according to the display device having the pixel circuit Pij including the second sub-dot unit Pijb thus configured, it is possible to improve the viewing angle characteristics, and to set the transmittances of both of the two sub-dot units to the level corresponding to the maximum gradation voltage, thereby increasing contrast.

### Third Embodiment

A liquid crystal display device according to a third embodiment of the present invention has the same configuration as that of the liquid crystal display device according to the first embodiment (FIG. 1). In the following, different points from the first and second embodiments are described.

FIG. 9 is an equivalent circuit diagram of a pixel circuit included in the liquid crystal display device according to this embodiment. Similarly to the first and second embodiments, the first sub-dot unit Pija includes the thin film transistor Qija and the liquid crystal element LCija. Similarly to the second embodiment, the second sub-dot unit Pijb includes the thin film transistors Qijb, Qijc, and Qijd, the liquid crystal element LCijb, and the capacitor Cijc that serves as a capacitive element.

The connection form of the thin film transistors Qija and Qijb is the same as the first and second embodiments. One electrodes of the liquid crystal elements LCija and LCijb (the electrodes that are not the common electrode Com) are respectively referred to as the dot electrodes Xij and Yij. The gate terminal of the thin film transistor Qijc is connected to the gate line Gi, and the drain terminal of the thin film transistor Qijc is connected to one electrode of the capacitor Cijc (hereinafter referred to as the dot electrode Zij). The source terminal of the thin film transistor Qijc is connected to the source line Sj when i is an odd number, and to the source line Sj+1 when i is an even number. The gate terminal of the thin film transistor Qijd is connected to the gate line Gi+1, and the drain terminal of the thin film transistor Qijd is connected to the dot electrode Zij. The source terminal of the thin film transistor Qijd is connected to the auxiliary capacitor line Ci when j is an odd number, and to the auxiliary capacitor line Ci+1 when j is an even number. The other electrodes of the liquid crystal elements LCija and LCijb are configured as the counter electrode Com that is common to all of the pixel circuits. The other electrode of the capacitor Cijc is connected to the dot electrode Yij.

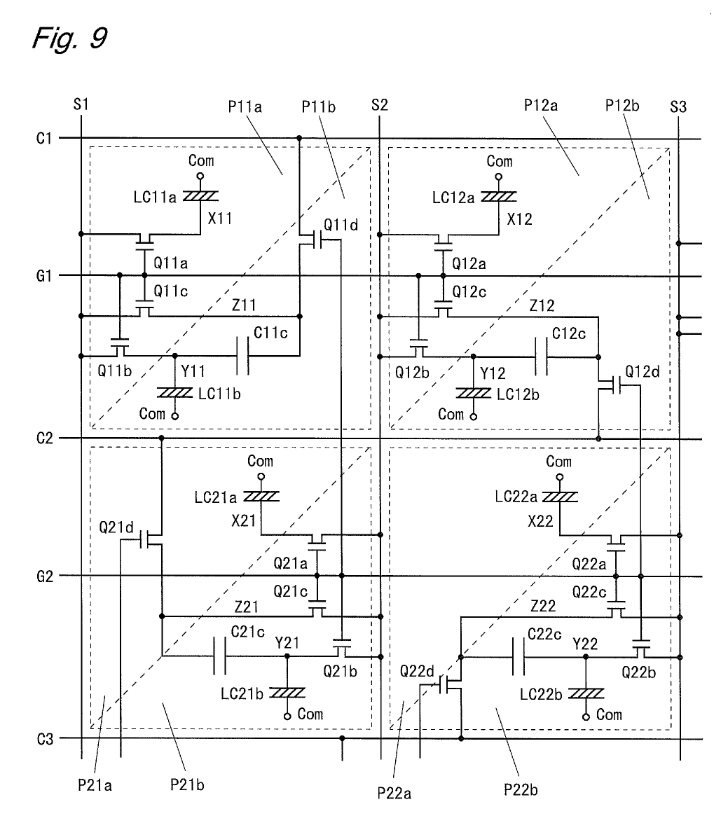

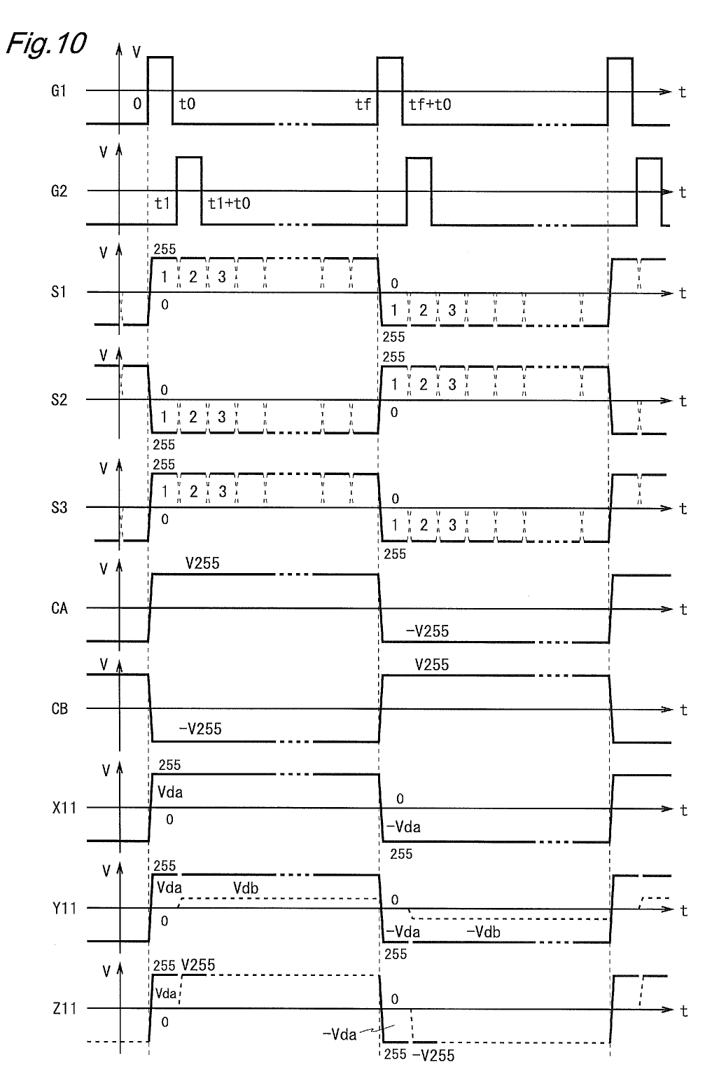

FIG. 10 is a signal waveform chart of the liquid crystal display device according to this embodiment. Similarly to FIG. 3, FIG. 10 illustrates changes of the voltages applied to the gate lines G1 and G2, the voltages applied to the source lines S1 to S3, the voltage of the auxiliary capacitor line signal CA, the voltage of the auxiliary capacitor line signal CB, and the voltages of the dot electrodes X11, Y11, and Z11 when the above voltages are applied.

A driving method of the liquid crystal display device according to this embodiment will be now described with reference to FIG. 10. In the frame period starting at the time 0, the auxiliary capacitor line driver 16 sets the voltage of the auxiliary capacitor line signal CA to the positive maximum gradation voltage V255, and the voltage of the auxiliary capacitor line signal CB to the negative maximum gradation voltage (−V255). In the frame period starting at the time tf, the auxiliary capacitor line driver 16 sets the voltage of the auxiliary capacitor line signal CA to the negative maximum gradation voltage (−V255), and the voltage of the auxiliary capacitor line signal CB to the positive maximum gradation voltage V255.

At the time 0, the gate driver 14 applies the selection voltage VH to the gate line G1. With this, the thin film transistors Q1ja, Q1jb, and Q1jc are turned to the ON state in the pixel circuits P1j in the first row. During the time period from the time 0 to the time t0, in order to write voltages to the pixel circuits P1j in the first row, the source driver 15 applies the positive gradation voltages to the odd-numbered source lines S1, S3, and so on, and the negative gradation voltages to the even-numbered source lines S2, S4, and so on.

During the time period from the time 0 to the time t0, in the pixel circuit P11, the positive gradation voltage is applied to the dot electrodes X11, Y11, and Z11 from the source driver 15 through the source line S1. This also applies to other pixel circuits P13, P15, and so on in the first row and the odd-numbered columns. In the pixel circuit P12, the negative gradation voltage is applied to the dot electrodes X12, Y12, and Z12 from the source driver 15 through the source line S2. This also applies to other pixel circuits P14, P16, and so on in the first row and the even-numbered columns.

Next, at the time t0, the gate driver 14 applies the non-selection voltage VL to the gate line G1. With this, the thin film transistors Q1ja, Q1jb, and Q1jc are turned to the OFF state in the pixel circuits P1j in the first row.

Then, at the time t1, the gate driver 14 applies the selection voltage VH to the gate line G2. With this, the thin film transistor Q1jd is turned to the ON state in the pixel circuits P1j in the first row, and the thin film transistors Q2ja, Q2jb, and Q2jc are turned to the ON state in the pixel circuits P2j in the second row. During the time period from the time t1 to the time (t1+t0), in order to write voltages to the pixel circuits P2j in the second row, the source driver 15 applies the positive gradation voltages to the odd-numbered source lines S1, S3, and so on, and the negative gradation voltages to the even-numbered source lines S2, S4, and so on.

During the time period from the time t1 to the time (t1+t0), in the pixel circuit P21, the negative gradation voltage is applied to the dot electrodes X21, Y21, and Z21 from the source driver 15 through the source line S2. This also applies to other pixel circuits P23, P25, and so on in the second row and the odd-numbered columns. In the pixel circuit P22, the positive gradation voltage is applied to the dot electrodes X22, Y22, and Z22 from the source driver 15 through the source line S3. This also applies to other pixel circuits P24, P26, and so on in the second row and the even-numbered columns. Further, in the pixel circuits P1j in the first row, the voltage of the dot electrode Z1j changes from the gradation voltage to the maximum gradation voltage, and the voltage of the dot electrode Y1j also changes along with this (details will be described later).

Next, at the time (t1+t0), the gate driver 14 applies the non-selection voltage VL to the gate line G2. With this, the thin film transistor Q1jd is turned to the OFF state in the pixel circuits in P1j of the first row, and the thin film transistors Q2ja, Q2jb, and Q2jc are turned to the OFF state in the pixel circuits P2j in the second row.

At the time to, electric charge in an amount corresponding to the gradation voltage applied from the source line S1 (source line voltage Vda) is stored in each of the liquid crystal elements LC11a and LC11b, and the electric charge stored in the capacitor C11c becomes zero. At the time t1, when the thin film transistor Q11c is turned to the OFF state and the thin film transistor Q11d is turned to the ON state, the voltage of the dot electrode Z11 changes from the gradation voltage to the maximum gradation voltage, and the voltage of the dot electrode Y11 also changes along with this. For the voltage Vdb of the dot electrode Y11 after the time t1, an expression (11) shown below is established. Therefore, the voltage Vdb is obtained by an expression (12) shown below.

Cb·Vda=Cb·Vdb+Cc·(Vdb−V255) (11)

Vdb=(Cb·Vda+Cc·V255)/(Cb+Cc) (12)

Here, Cb represents a capacitance value of the liquid crystal element LCijb, and Cc represents a capacitance value of the capacitor Cijc.

Next, effects of the liquid crystal display device according to this embodiment will be described. Here, when it is assumed that Cb=4Cc, an expression (13) shown below is derived.

Vdb=(4·Vda+V255)/5 (13)

The expression (13) is the same as the expression (7) derived in the first embodiment. Accordingly, a relation between the source line voltage Vda and a voltage applied to liquid crystals in the liquid crystal display device according to this embodiment is the same as that shown in FIG. 4. Therefore, similarly to the liquid crystal display device 10 of the first embodiment, according to the liquid crystal display device of this embodiment, when writing a voltage other than the maximum gradation voltage V255 to the pixel circuit Pij, it is possible to improve viewing angle characteristics by writing different voltages to the two sub-dot units Pija and Pijb. In addition, similarly to the first embodiment, when writing the maximum gradation voltage V255 to the pixel circuit Pij, it is possible to set the transmittances of both of the two sub-dot units to a level corresponding to the maximum gradation voltage by writing the same voltage to the two sub-dot units Pij a and Pijb, thereby increasing contrast.

As described above, according to the liquid crystal display device of this embodiment, the second sub-dot unit Pijb includes, as a capacitive element, the capacitor Cijc having a first terminal and a second terminal. The thin film transistor Qijc (third active element) is provided between the first terminal of the capacitor Cijc and the source line Sj (or the source line Sj+1), the thin film transistor Qijd (fourth active element) is provided between the first terminal of the capacitor Cijc and the auxiliary capacitor line Ci (or the auxiliary capacitor line Ci+1), and the second terminal of the capacitor Cijc is connected to the one terminal of the liquid crystal element LCijb (the terminal on the side of the thin film transistor Qijb as the second active element).

During the selection period, the thin film transistors Qij a, Qijb, and Qij c are turned to the ON state, and the gradation voltage is applied to the liquid crystal elements LCij a and LCijb, and the two terminals of the capacitor Cijc from the source line. At this time, electric charge in an amount corresponding to the gradation voltage is stored in the liquid crystal element LCijb, and the electric charge stored in the capacitor Cijc becomes zero. During the voltage adjustment period, the thin film transistor Qijd is turned to the ON state, and the maximum gradation voltage is applied to the first terminal of the capacitor Cijc from the auxiliary capacitor line. In a case in which a voltage other than the maximum gradation voltage has been applied to the source line during the selection period, the voltage applied to the liquid crystal element LCijb changes when the voltage is applied to the first terminal of the capacitor Cijc from the auxiliary capacitor line. By contrast, in a case in which the maximum gradation voltage has been applied to the source line during the selection period, the voltage applied to the liquid crystal element LCijb does not change even if the voltage is applied to the first terminal of the capacitor Cijc from the auxiliary capacitor line. Accordingly, in the second sub-dot unit Pijb, when shifting to the voltage adjustment period, the voltage applied to the liquid crystal element LCijb changes according to changes in states of the thin film transistors Qijb, Qijc, and Qijd, excluding the case in which the maximum gradation voltage has been applied to the source line during the selection period. Therefore, according to the display device having the pixel circuit Pij including the second sub-dot unit Pijb thus configured, it is possible to improve the viewing angle characteristics, and to set the transmittances of both of the two sub-dot units to the level corresponding to the maximum gradation voltage, thereby increasing contrast.

In the first to third embodiments, the liquid crystal display device using the TN liquid crystals in the normally white mode is described as an example of the display device according to the present invention. However, the present invention is also applicable to liquid crystal display devices, for example, in a VATN mode which is a normally black mode. The VATN mode which is one type of a VA mode is described below.

In a liquid crystal display device in the VATN mode, a pixel circuit is provided on a liquid crystal panel having a first substrate, a second substrate, a liquid crystal layer disposed between the first and second substrates, a first alignment film disposed on a surface of the first substrate facing toward the liquid crystal layer, and a second alignment film disposed on a surface of the second substrate facing toward the liquid crystal layer. The liquid crystal layer includes liquid crystal molecules having a negative dielectric anisotropy.

FIG. 11 is a view illustrating a working principle of the liquid crystal display device in the VATN mode. FIG. 11(a) shows an OFF state, and FIG. 11(b) shows an ON state. In FIGS. 11(a) and 11(b), an alignment orientation 43 represents an alignment orientation of a first alignment film (not depicted) provided on a surface of a first substrate 41 facing toward a liquid crystal layer. An alignment orientation 44 represents an alignment orientation of a second alignment film (not depicted) provided on a surface of a second substrate 42 facing toward the liquid crystal layer. As shown in FIG. 11(a), in the OFF state in which a voltage applied to the two substrates 41 and 42 that sandwich the liquid crystal layer is lower than a threshold voltage, the first alignment film and the second alignment film cause liquid crystal molecules 40 to be aligned substantially vertically to surfaces of the alignment films (substrate surfaces) and in the orientations perpendicular to each other. Further, as shown in FIG. 11(b), in the ON state in which the voltage applied to the two substrates 41 and 42 that sandwich the liquid crystal layer exceeds the threshold voltage, the liquid crystal molecules 40 having a negative dielectric anisotropy are aligned in parallel with the substrate surfaces according to the applied voltage, showing a birefringent property to light transmitted through the liquid crystal panel.

As used herein, the alignment orientation of the liquid crystal molecule indicates an orientation when a tilt direction of the liquid crystal molecule is projected onto the substrate surface. Further, the phrase “causing the liquid crystal molecules to be aligned in the orientations perpendicular to each other” does not necessarily mean to cause the liquid crystal molecules to be aligned so as to be perfectly perpendicular to each other, as long as the liquid crystal molecules are aligned in the orientations substantially perpendicular to each other to a magnitude that allows displaying by liquid crystals in the VATN mode. It is preferable that the alignment orientations of the first alignment film and the second alignment film are at an angle from 85 to 95 degrees to each other.

The first substrate 41 is subjected to an alignment process along the alignment orientation 43, in order to make a pretilt angle of the liquid crystal molecules 40 in a neighborhood of the first alignment film to be 87 to 89 degrees. Further, the second substrate 42 is subjected to an alignment process along the alignment orientation 44, in order to make a pretilt angle of the liquid crystal molecules 40 in a neighborhood of the second alignment film to be 87 to 89 degrees. It should be noted that an angle between the alignment film surface and a long axis direction of the liquid crystal molecule in the neighborhood of the alignment film (an angle θ in FIG. 13) is referred to as a tilt angle, and the tilt angle in the OFF state in which a voltage lower than the threshold voltage is applied to the liquid crystal layer is referred to as a pretilt angle.

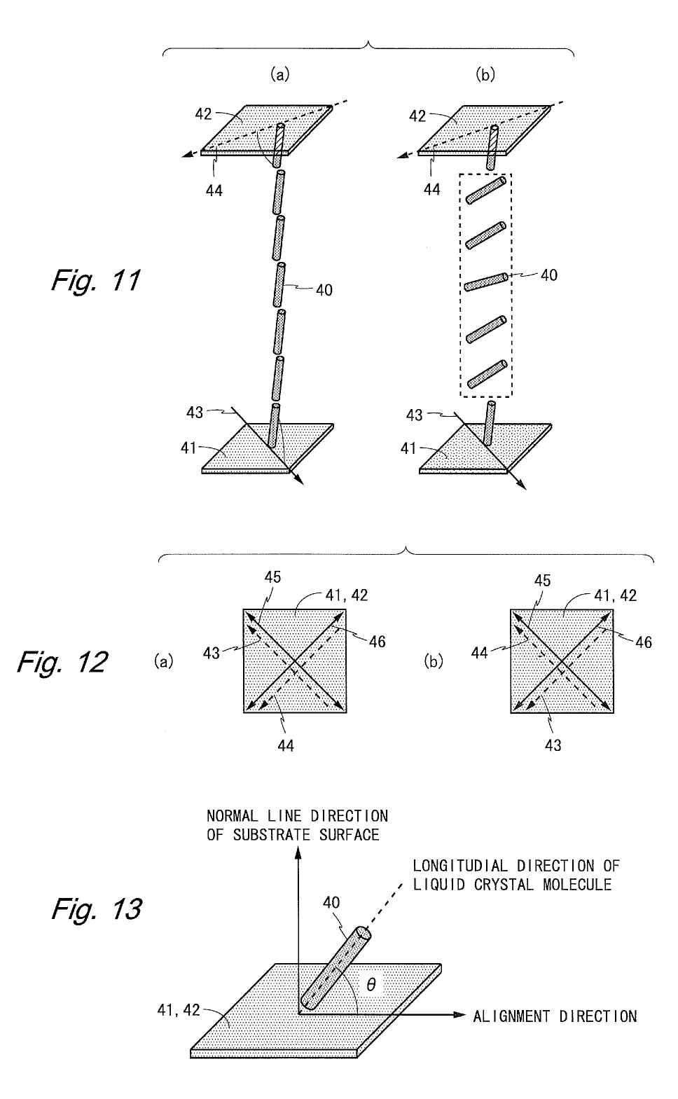

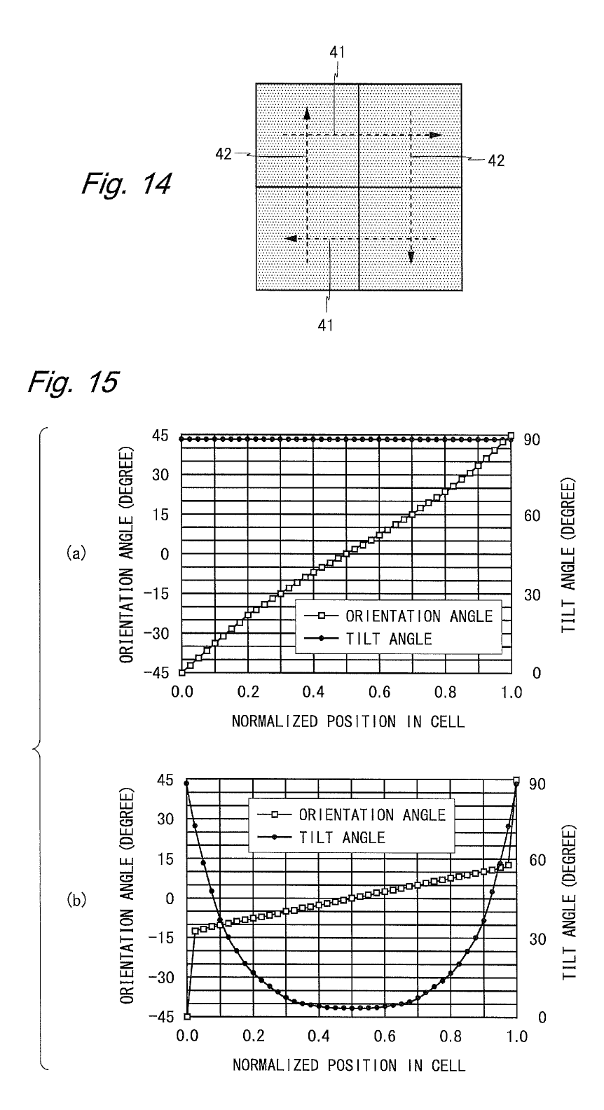

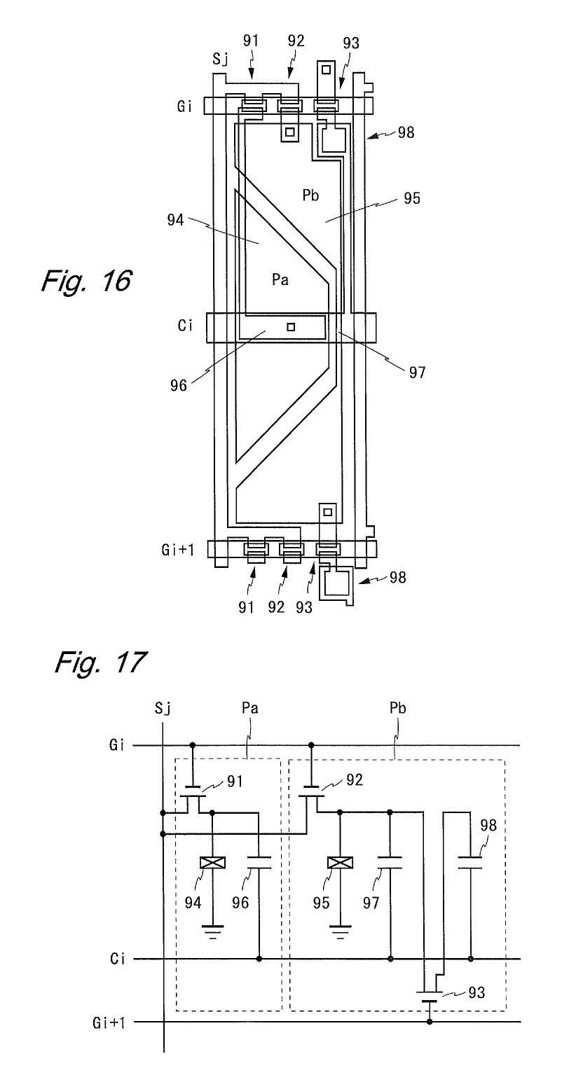

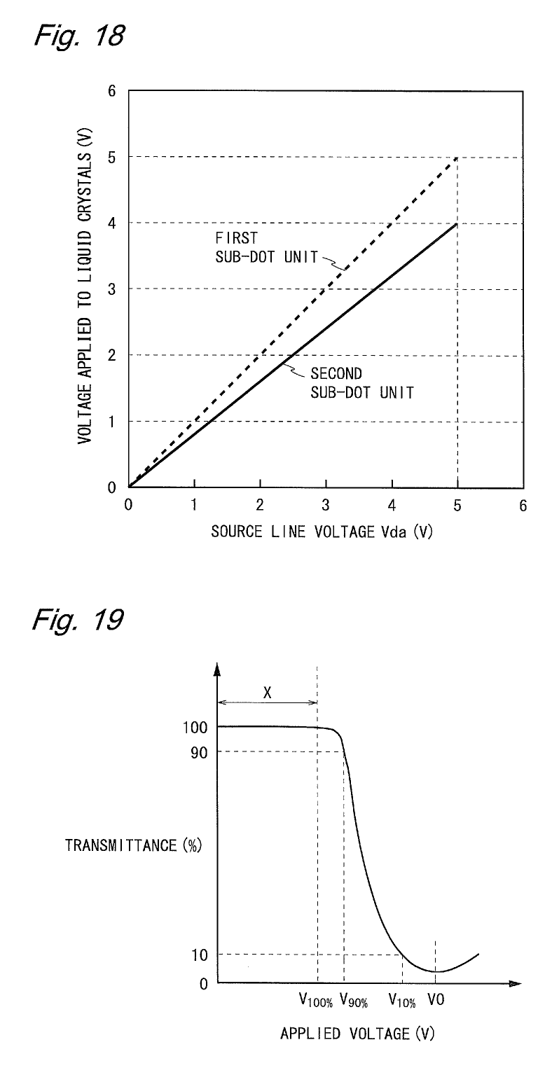

Next, as shown in FIG. 14, the first substrate 41 and the second substrate 42 are combined such that processing directions of the alignment become perpendicular to each other, and four domain areas having different twisting directions of the liquid crystal molecules 40 are provided in each pixel. When combining the polarizing plates to the first substrate 41 and the second substrate 42, a positional relation between the alignment orientations 43 and 44 of the alignment films and absorption axes 45 and 46 of the polarizing plates is set as shown in FIG. 12(a) or in FIG. 12(b). With this, a liquid crystal panel in the VATN mode is completed. In FIG. 12(a), the absorption axis 45 of the first polarizing plate and the alignment orientation 43 of the first alignment film are in the same direction, and the absorption axis 46 of the second polarizing plate and the alignment orientation 44 of the second alignment film are in the same direction. In FIG. 12(b), the absorption axis 45 of the first polarizing plate and the alignment orientation 44 of the second alignment film are in the same direction, and the absorption axis 46 of the second polarizing plate and the alignment orientation 43 of the first alignment film are in the same direction.

FIG. 15 is a chart showing alignments of the liquid crystal element in the liquid crystals in the VATN mode. As shown in FIG. 15, an orientation angle and a pretilt angle of the liquid crystal molecule change according to a position within a cell (a position between the two substrates). FIG. 15(a) shows the alignment in the OFF state, and FIG. 15(b) shows the alignment in the ON state. It should be noted that the pretilt angles in the neighborhood of the first alignment film and the second alignment film are both 88.5 degrees.

As shown in FIG. 15(a), in the OFF state in which the voltage applied to the two substrates 41 and 42 is lower than the threshold voltage, the tilt angle of the liquid crystal molecule 40 is constant at 88.5 degrees, and the orientation angle of the liquid crystal molecule 40 changes at a substantially constant rate from −45 degrees to +45 degrees from the first substrate 41 toward the second substrate 42. By contrast, as shown in FIG. 15(b), in the ON state in which the voltage applied to the two substrates 41 and 42 exceeds the threshold voltage, while the tilt angle of the liquid crystal molecule 40 is maintained such that the liquid crystal molecule is aligned substantially vertically by the alignment films in the neighborhood of the first alignment film and the second alignment film, the tilt angle changes at a central portion distant from the alignment films such that the liquid crystal molecule is aligned substantially horizontally by the voltage applied to the liquid crystal layer. At this time, the orientation angle of the liquid crystal molecule 40 changes to a large extent at almost the same rate between the neighborhood of the first alignment film and the neighborhood of the second alignment film, and changes, at the central portion distant from the alignment films, to a small extent at a constant rate from the first substrate 41 toward the second substrate 42. The reason for this is considered to be because the alignment is maintained to be substantially vertical in the neighborhood of the first alignment film and in the neighborhood of the second alignment film, and therefore twisting the liquid crystal molecule 40 changes the orientation angle with an energy smaller than in the central portion distant from the alignment films. Further, high transmittance can be obtained, as the pretilt angles are equal between the neighborhood of the first alignment film and the neighborhood of the second alignment film, and as the changes in the orientation angles (the twisting of the liquid crystal molecule) is symmetric between a side of the first substrate and a side of the second substrate. It should be noted that it is possible to obtain substantially the same effects as long as a difference between the pretilt angles of the liquid crystal molecule 40 in the neighborhood of the first alignment film and that in the neighborhood of the second alignment film is not greater than 1 degree.

The liquid crystal display device in the VATN mode has a problem that when a voltage not lower than a certain limitation voltage (a voltage corresponding to V255) is written to the pixel circuit, a symmetric property in angles is lost in the pretilt angles, and tones of color and brightness change depending on the viewing angle. Accordingly, by an application of the present invention to the liquid crystal display device in the VATN mode, it is possible to prevent a voltage not lower than the limitation voltage from being written to the pixel circuit, and thus the above problem can be solved. Further, by applying different voltages respectively to the two sub-dot units when writing a voltage lower than the limitation voltage to the pixel circuit, it is possible to improve the viewing angle characteristics.

### INDUSTRIAL APPLICABILITY

The display device according to the present invention has a feature in that when a single pixel is constituted by a plurality of sub-dots, the transmittances of all of the plurality of sub-dots can be set to a level corresponding to the maximum gradation voltage, and can be utilized for various active matrix-type display devices such as the liquid crystal display device.

### DESCRIPTION OF REFERENCE CHARACTERS

10, 20: LIQUID CRYSTAL DISPLAY DEVICE

11, 21: LIQUID CRYSTAL CONTROLLER

12, 22: LIQUID CRYSTAL PANEL

13: DISPLAY UNIT

14: GATE DRIVER

15: SOURCE DRIVER

16, 26: AUXILIARY CAPACITOR LINE DRIVER

40: LIQUID CRYSTAL MOLECULE

41, 42: SUBSTRATE

43, 44: ALIGNMENT ORIENTATION

45, 46: ABSORPTION AXIS

G1 to Gm: GATE LINE (SCANNING SIGNAL LINE)

S1 to Sn+1: SOURCE LINE (VIDEO SIGNAL LINE)

C1 to Cm+1: AUXILIARY CAPACITOR LINE (CONTROL LINE)

Pij: PIXEL CIRCUIT

Pija: FIRST SUB-DOT UNIT

Pijb: SECOND SUB-DOT UNIT

LCija: LIQUID CRYSTAL ELEMENT (FIRST DISPLAY ELEMENT)

LCijb: LIQUID CRYSTAL ELEMENT (SECOND DISPLAY ELEMENT)

LCijc: LIQUID CRYSTAL ELEMENT (CAPACITIVE ELEMENT)

Cijc: CAPACITOR (CAPACITIVE ELEMENT)

Qija: THIN FILM TRANSISTOR (FIRST ACTIVE ELEMENT)

Qijb: THIN FILM TRANSISTOR (SECOND ACTIVE ELEMENT)

Qijc: THIN FILM TRANSISTOR (THIRD ACTIVE ELEMENT)

Qijd: THIN FILM TRANSISTOR (FOURTH ACTIVE ELEMENT)

Xij, Yij, Zij: DOT ELECTRODE

1. An active matrix-type display device, comprising:
a plurality of scanning signal lines;
a plurality of video signal lines;
a plurality of control lines to which a maximum gradation voltage is applied, the maximum gradation voltage being a voltage whose absolute value is maximum among gradation voltages applied to the video signal lines; and
a plurality of pixel circuits respectively provided corresponding to intersections between the scanning signal lines and the video signal lines, each pixel circuit including a first sub-dot unit and a second sub-dot unit, wherein
the first sub-dot unit includes:
a first display element having a capacitance; and
a first active element provided between a corresponding one of the video signal lines and one terminal of the first display element, and configured to be turned to an ON state during a selection period of a corresponding one of the scanning signal lines,
the second sub-dot unit includes:
a second display element having a capacitance;
a second active element provided between the corresponding one of the video signal lines and one terminal of the second display element, and configured to be turned to the ON state during the selection period;
a capacitive element having a first terminal and a second terminal;
a third active element configured to be turned to the ON state during the selection period; and
a fourth active element configured to be turned to the ON state during a voltage adjustment period following the selection period, and
the second sub-dot unit is configured such that when shifting to the voltage adjustment period, a voltage applied to the second display element changes according to changes in states of the second to fourth active elements, excluding a case in which the maximum gradation voltage has been applied to the corresponding one of the video signal lines during the selection period.

2. The display device according to claim 1, wherein
the third active element is provided between the first terminal and a corresponding one of the control lines, and
the fourth active element is provided between the first terminal and the one terminal of the second display element.

3. The display device according to claim 1, wherein
the third active element is provided between the first terminal and a corresponding one of the control lines,
the fourth active element is provided between the first terminal and the second terminal, and
the second terminal is connected to the one terminal of the second display element.

4. The display device according to claim 1, wherein
the third active element is provided between the first terminal and the corresponding one of the video signal lines,
the fourth active element is provided between the first terminal and a corresponding one of the control lines, and
the second terminal is connected to the one terminal of the second display element.

5. The display device according to claim 1, wherein
the voltage adjustment period coincides with a selection period of a subsequent one of the scanning signal lines.

6. The display device according to claim 1, wherein
the pixel circuit is provided on a liquid crystal panel having a first substrate, a second substrate, a liquid crystal layer disposed between the first and second substrates, a first alignment film disposed on a surface of the first substrate facing toward the liquid crystal layer, and a second alignment film disposed on a surface of the second substrate facing toward the liquid crystal layer,
the liquid crystal layer includes liquid crystal molecules having a negative dielectric anisotropy, and
the first and second alignment films cause the liquid crystal molecules to be aligned substantially vertically to surfaces of the films and in orientations perpendicular to each other.

7. The display device according to claim 6, wherein
a pretilt angle of the liquid crystal molecule in the neighborhood of the first and second alignment films is not greater than 89 degrees.

8. The display device according to claim 6, wherein
each of the first and second alignment films within each pixel circuit includes two or more areas having different alignment orientations.
